(19) United States
(12) Patent Application Publication
(10) Pub. No.: US 2019/0378200 A1
(43) Pub. Date: Dec. 12, 2019

(54) System, Method and Apparatus for Integration of Purchasing Items within Print Material

(71) Applicant: Riley Costello, Newport Beach, CA (US)

(72) Inventor: Riley Costello, Newport Beach, CA (US)

(21) Appl. No.: 16/434,073

(22) Filed: Jun. 6, 2019

Related U.S. Application Data
(60) Provisional application No. 62/681,553, filed on Jun. 6, 2018.

(51) Int. Cl. G06Q 30/06

(52) U.S. Cl. CPC G06Q 30/0635; G06Q 30/0641

(57) ABSTRACT

A computerized method for providing a virtualized shopping experience on a network device is disclosed. The method includes operations of detecting, by an e-reader software application processing on the network device, first user input corresponding to selection of an indicator within an e-book, displaying, by the e-reader software application, an image depicting a first item, responsive to receiving second user input indicating selection of the first item, adding, by the e-reader software application, the first item to a virtual shopping cart, and responsive to receiving third user input, completing, by the e-reader software application, a virtualized check out process. Additionally, operations of the computerized method may be provided by a plug-in software application that communicates with the e-reader software application via an application programming interface (API).

### CROSS-REFERENCE TO RELATED APPLICATIONS

This application claims the benefit of priority to U.S. Provisional Application No. 62/681,553, filed Jun. 6, 2018, the entire contents of which are incorporated by reference herein.

### FIELD

Embodiments of the disclosure relate to the field of consumer purchasing systems and methodologies. More specifically, one embodiment of the disclosure relates to a system for purchasing items while reading print material, such as a printed book or electronic print material.

### GENERAL BACKGROUND

The use of electronic print readers, often referred to as “e-readers” has become mainstream. E-readers provide a reader access to millions of books in a digital format allowing the reader to easily “carry” a large number of books at a single time. A book stored in a digital format may be referred to as an “e-book.” For instance, an e-reader may be an electronic device that has access to the internet and provides the reader access to one of many virtual bookstores. The reader may browse, buy, download and read e-books with the e-reader. The e-reader may contain a physical storage medium that stores the e-books. Additionally, the e-books may also be stored in cloud storage accessible through the internet.

While reading a book, e.g., e-book or traditional print, the reader is often envisioning a scene taking place in the book. For example, a reader may envision how a character looks, what a character is wearing, what additional items a character is carrying, etc. However, as is the case with traditional books, a reader does not have the luxury of being able to actually see the author's take on how a character looks or what items a character carries, drives, etc. while reading.

What has been needed, and previously unavailable, is a system, method and apparatus enabling a reader of a book to visualize a scene or a photo of a character within the book and to shop items appearing in the scene or the photo directly from the e-reader and/or mobile device assisting in the process in a print book.

### BRIEF DESCRIPTION OF THE DRAWINGS

Embodiments of the invention are illustrated by way of example and not by way of limitation in the figures of the accompanying drawings, in which like references indicate similar elements and in which:

FIGS. 1A-1B show a flowchart illustrating a first embodiment of disclosure in accordance with some embodiments;

FIGS. 2A-2B show a flowchart illustrating a second embodiment of disclosure in accordance with some embodiments;

FIGS. 3A-3B show a flowchart illustrating a third embodiment of disclosure in accordance with some embodiments; and

FIG. 4 shows a block diagram of an exemplary embodiment of a network device including an e-reader software application and, optionally, an e-reader plug-in, installed thereon in accordance with some embodiments.

### DETAILED DESCRIPTION

In a first embodiment, the present invention includes a system, method and apparatus describing the integration of purchasing items within electronic print and using an electronic device to facilitate the same process in print. Some embodiments disclose a system that enables readers of electronic print to make purchases with an electronic print reading application such as on an electronic tablet. For example, one embodiment may disclose a non-transitory, computer-readable medium that stores instructions thereon such that the instructions are executable by one or more processors of a network device to display electronic print, e.g., an electronic version of a novel, on a display screen of the network device and, responsive to user input, place one or more items in a virtual shopping cart, wherein information corresponding to the one or more items are accessible from electronic links within the electronic print. Herein, although a novel is used in the discussing example embodiments, the disclosure may apply to any electronic print such as any electronic book (“e-book”), magazines in electronic print, newspapers in electronic print, etc.

More specifically, as one non-limiting example, one embodiment may include a software application downloadable (i.e., an e-reader software application or “e-reader” or a plug-in associated therewith) on a network device such as a tablet, mobile phone, etc. A plug-in, or “extension” may be a code module that is downloadable and installed on a network device and provides additional functionality to one or more software applications via an API.

For simplicity, a tablet will be discussed in some embodiments disclosed herein but the disclosure is not intended to be so limiting. In particular, the e-reader may be executable by processors of the tablet and configured to display electronic print, such as an e-book, on the screen of the tablet. In addition, the e-reader, or plug-in, is configured to display electronic links (or otherwise referred to as “indicators”) within the e-book. When user input is received by the plug-in selecting an electronic link, the plug-in may be configured to generate a pop-up window within the e-reader (e.g., as an overlay on top of the electronic print). In one embodiment, an example of user input may include receipt of pressure on the screen of the tablet. Additionally, examples of the electronic links may include, but are not limited or restricted to: (1) a visual indication on a particular word or words within the electronic print such as a formatting style that is different than the majority of the formatting style of the electronic print: (i) a different color, (ii) a different font, (iii) a different size, (iv) underline, (v) bold, (vi) italics, etc.; (2) a picture within the electronic text, for example illustrating a scene being described by the electronic print currently displayed on the screen of the tablet; (3) etc.

In particular, the virtual shopping cart is included within the e-reader or plug-in such that a reader does not have to leave the e-reader to view an item and place the item in the virtual shopping cart. The inclusion of the virtual shopping cart within the e-reader may also be referred to as being “integrated” into the e-reader. With respect to embodiments utilizing a plug-in to provide the virtual shopping cart, the plug-in provides the e-reader with the additional functionality of the virtual shopping cart that enables a reader to utilize the virtual shopping cart without leaving the e-reader. For example, a reader may provide input resulting in the selection of an electronic link within the electronic print displayed by the software application. In response to the selection of the electronic link, the software application may generate a pop-up window as an overlay on top of the electronic print that illustrates a character from the novel wearing particular clothing items and/or including additional items. In one embodiment, the pop-up window may include a description of each item below the illustration. In a second embodiment, the pop-up may include a visual indicator for each (e.g., a number corresponding to each item shown in the illustration). As used herein, the term “illustration” may refer to a visualization including a picture as well as a video.

Once the reader has viewed the pop-up, the reader may then provide user input corresponding to the selection of one or more of the items to add to the virtual shopping cart within the e-reader or plug-in. For example, the reader may desire to purchase a blouse or hat that a character is wearing in the illustration. The reader may provide user input that selects the hat and blouse, along with requisite information such as sizing and color, when applicable, resulting in the item(s) being added to the virtual shopping cart. In one embodiment, the reader may provide additional user input causing the reader to virtually “check out” and purchase the item(s) in the virtual shopping cart, wherein such additional user input may include payment information (billing, shipping, etc.).

In a second embodiment, the reader may close the pop-up window, continue reading and select to virtually check out at a later time, e.g., upon finishing a chapter or prior to leaving the e-reader. Further, in some embodiments, the e-reader or plug-in may provide a pop-up or other alert configured to remind the reader to virtually check out prior to closing the e-reader. For example, upon receiving user input directed at closing the e-reader, the e-reader or plug-in may generate a pop-up reminding the reader to virtually check out, and may provide a link to the virtual shopping cart.

Additionally, the reader may add items to the virtual shopping cart from multiple electronic links (e.g., a first item shown in a first illustration corresponding to a first electronic link and a second item shown in a second illustration corresponding to a second electronic link).

In other embodiments discussed below, the same principles may be applied to physical print material (e.g., physical paperback or hardcover books). In such embodiments, the indicator may be physically located on a page (e.g., printed or embossed, etc.) and configured to be scanned by a network device having an e-reader and/or plug-in installed thereon, as discussed above. Specifically, the scanning of a code may cause the e-reader or plug-in to display one or more items in a pop-up or otherwise as discussed above. In some situations, the scanning of a code may prompt the opening and initiation of the e-reader and/or plug-in as well.

### I. Terminology

In the description, certain terminology is used to describe various features of the invention. For example, each of the terms “logic” and “component” may be representative of hardware, firmware or software that is configured to perform one or more functions. As hardware, the term logic (or component) may include circuitry having data processing and/or storage functionality. Examples of such circuitry may include, but are not limited or restricted to a hardware processor (e.g., microprocessor, one or more processor cores, a digital signal processor, a programmable gate array, a microcontroller, an application specific integrated circuit “ASIC”, etc.), a semiconductor memory, or combinatorial elements.

Additionally, or in the alternative, the logic (or component) may include software such as one or more processes, one or more instances, Application Programming Interface(s) (API), subroutine(s), function(s), applet(s), servlet(s), routine(s), source code, object code, shared library/dynamic link library (dll), or even one or more instructions. This software may be stored in any type of a suitable non-transitory storage medium, or transitory storage medium (e.g., electrical, optical, acoustical or other form of propagated signals such as carrier waves, infrared signals, or digital signals). Examples of a non-transitory storage medium may include, but are not limited or restricted to a programmable circuit; non-persistent storage such as volatile memory (e.g., any type of random access memory “RAM”); or persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the logic (or component) may be stored in persistent storage.

The term “print material” generally refers to either traditional printed text such as books, magazines, advertisements, newspapers, etc., printed on paper or the like as well as digitally printed text.

The term “electronic device” may be construed as any electronic computing system with the capability of processing data. In addition, an electronic device may include the ability to connect to a network. Such a network may be a public network such as the Internet or a private network such as a wireless data telecommunication network, wide area network, a type of local area network (LAN), or a combination of networks. Examples of an electronic device may include, but are not limited or restricted to, an endpoint device (e.g., a laptop, a mobile phone, a tablet, a computer, etc.), a standalone appliance, a server, a router or other intermediary communication device, a firewall, etc.

The term “indicator” may refer to electronic links within text displayed within an e-reader, an illustration displayed within an e-reader, a code or unique icon or image (e.g., a barcode). The electronic links may appear as “key words” within the text of an e-reader (e.g., that appear different than the majority of the text, such as a different color, different font, different size, bold, etc. The electronic links may also appear as pictures or other display items. Specifically, these indicators may be activated, e.g., clicked, which may cause a pop-up to be displayed (or another window, page, screen, etc.) that illustrates particular items relevant to the text. The items may include anything relevant to the text, with examples including, but not limited or restricted to, clothing, stationary, serving accessories (cups, plates, wine glasses), candles, pillows, blankets, rugs, etc. However, it should be noted that the items need not be relevant to the text. Instead, the items may be various items to purchase from sponsors or advertisements. The items may also be rebates or coupons. Further, the items may be exclusive content, such as celebrity interviews or author insight. With respect to the items not for purchase (rebates, exclusive content, etc.), the item may be required to be added to a virtualized shopping cart and a virtual check out completed (although without cost to the reader). In some embodiments, a purchase of an item may be required before activation or viewing of the items such as rebates or exclusive content.

Finally, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive. As this invention is susceptible to embodiments of many different forms, it is intended that the present disclosure is to be considered as an example of the principles of the invention and not intended to limit the invention to the specific embodiments shown and described.

### II. General Methodology—E-Book Embodiment

In some embodiments, a software application as discussed herein may be a stand-alone electronic print reader, e.g., “an e-book reader,” or “an e-reader” that includes the additional, novel functionality as described above. In other embodiments, the software application may be a plug-in that is configured to integrate with existing e-readers such that that the e-reader's logic displays an e-book and the plug-in provides the additional functionality discussed above with respect to providing the electronic links within the electronic print and the functionality that enables the reader to virtually check out and purchase items directly from a virtual shopping cart without leaving the e-reader application. In such an embodiment, the plug-in may be downloadable via an “app store” such as the Apple App Store, and configured to communicatively couple with the e-reader application via an Application Programming Interface (“API”) or other software integration method. Additionally, multiple versions of the software application may exist and be downloadable in order to properly execute according to an e-reader version or an operating system of the network device (e.g., Apple's iOS, Android's operating system, etc.). The software application may enable readers to purchase e-books directly, e.g., from a virtual bookstore within the software application. Additionally, in some embodiments, the software application may allow a reader to download an e-book from an existing virtual bookstore such as Amazon's Kindle Store.

The embodiments discussed herein solve a problem with traditional print books as well as e-readers displaying e-books. In particular, the problem centers around the inability of the reader to visualize a scene or imagine what a character looks like, if such is desired by the reader. Subsequent to solving the problem of enabling the reader the opportunity to visualize a scene from the book, an opportunity to market the items displayed in the scene arose. The embodiments discussed herein also capitalize on such an opportunity by providing functionality that enables the reader to shop the items displayed in the scene by incorporating a virtual shopping cart into the e-reader software, either via use of a proprietary e-reader software that includes the virtual shopping cart, via a plug-in that communicatively couples to an existing e-reader, or (in print books) through a software that couples to an app or devise that can replicate this function. Thus, the embodiments discussed herein provide companies, such as clothing companies, the opportunity to market their products through both print and e-books. For instance, a novel that receives a lot of acclaim may be used by a clothing company to market their clothing line by having illustrations within an e-book utilize their clothing line.

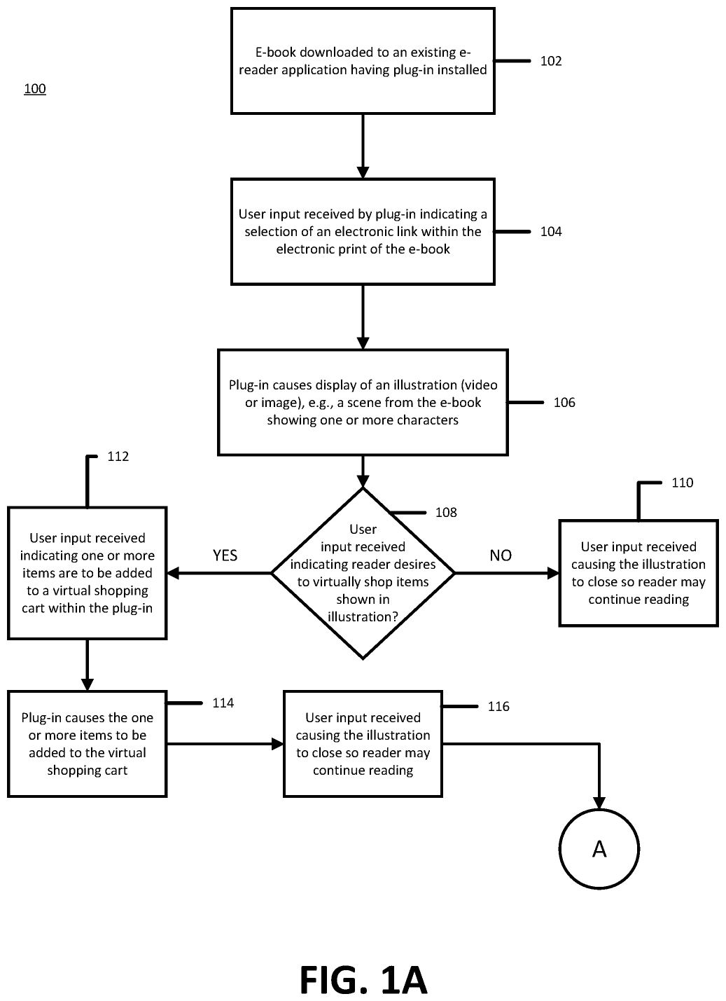

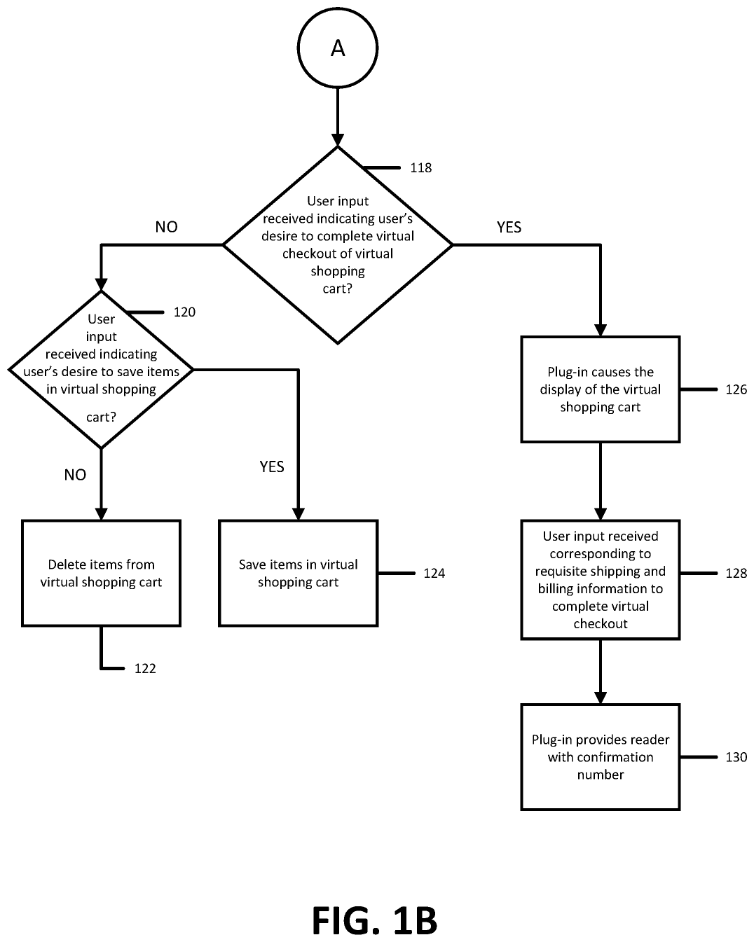

Referring now to FIGS. 1A-1B, a flowchart illustrating a first embodiment of the disclosure in which a plug-in is installed on a network device and configured for use with an e-reader software application, wherein the plug-in integrates a virtual shopping cart thereby enabling readers to purchase items relevant to the textual content directly from the e-reader software application (“e-reader”) in accordance with some embodiments. Each block illustrated in FIGS. 1A-1B represents an operation performed in the method 100 of receiving user input within an e-reader corresponding to a selection of one or more items to place in a virtual shopping cart integrated with the e-reader via a plug-in associated with the e-reader software application. The method 100 begins when an e-book is downloaded or made accessible to an existing e-reader application installed on a first network device having the plug-in discussed above installed thereon (block 102). Next, user input is received by the plug-in indicating a selection of an electronic link within the electronic print of the e-book (block 104). Following receipt of the user input, the plug-in causes display of an illustration, such as an illustration described in the content of the print material (106). However, in some embodiments, a particular illustration need not be shown, and instead, only items for purchased or other rebates, coupons, etc., displayed.

A determination is then made by the plug-in as to whether additional user input has been received indicating the reader desires to virtually shop items displayed (block 108). When user input is not received indicating the reader desires to virtually shop, user input may be received causing the illustration to close enabling the reader to continue reading (block 110).

When user input is received indicating the reader desires to virtually shop, the plug-in receives user input indicating one or more items are to be added to a virtual shopping cart within the e-reader software (i.e., via the added functionality provided by the plug-in) (block 112). Following receipt of the user input indicating one or more items are to be added to the virtual shopping cart, the plug-in causes the one or more items to be added to the virtual shopping cart (block 114). Additional user input is then received causing the illustration to close so that the reader may continue reading (block 116). Alternatively, the plug-in may automatically close the illustration after expiration of a predetermined time interval.

Further user input may be received indicating the user's desire to complete the virtual checkout, such a determination is made at block 118. When no user input has been received indicating a desire to complete the virtual check out, a determination is made as to whether user input is received indicating a user's desire to save the status of the virtual shopping cart (e.g., maintain the items in the virtual shopping cart) (block 120). When user input is not received that indicates the user desires to save the status of the virtual shopping cart, the plug-in deletes the one or more items from the virtual shopping cart (block 122). In contrast, when such user input is received, the plug-in saves the status of the virtual shopping cart for utilization, e.g., check out, at a later time (block 124).

When user input has been received indicating a desire to complete the virtual check out, the plug-in causes the display of a virtual shopping cart (block 126). Further, user input is received corresponding to requisite shipping and billing information in order to complete the virtual check out (block 128). Finally, the plug-in provides the reader with an order confirmation number (130).

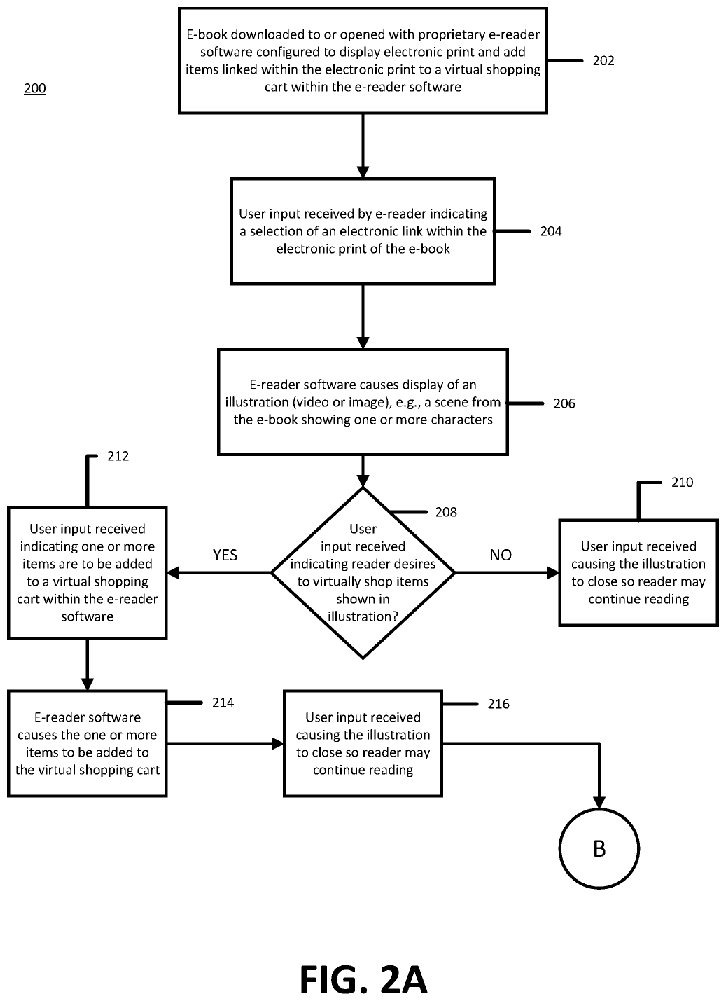

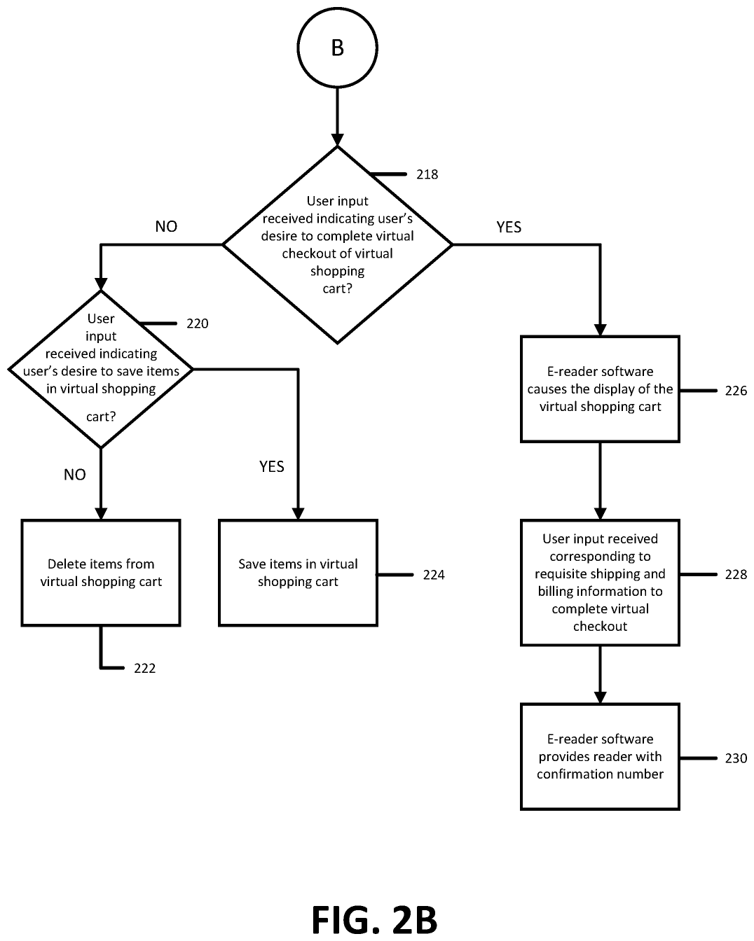

Referring now to FIGS. 2A-2B, a flowchart illustrating a second embodiment of the disclosure in which an e-reader is installed on a network device, wherein the e-reader software has integrated therein a virtual shopping cart thereby enabling readers to purchase items relevant to the textual content directly from the e-reader in accordance with some embodiments. Each block illustrated in FIGS. 2A-2B represents an operation performed in the method 200 of receiving user input within an e-reader software application corresponding to a selection of one or more items to place in a virtual shopping cart integrated directly within the e-reader software application. The method 200 begins when an e-book is downloaded or made accessible to an existing e-reader application installed on a first network device wherein the e-reader application includes functionality to receive user input corresponding to selection of links within the print material and facilitate a virtualized shopping experience directly within the e-reader application (block 202). Next, user input is received by the e-reader indicating a selection of an electronic link within the electronic print of the e-book (block 204). Following receipt of the user input, the e-reader causes display of an illustration, such as an illustration described in the content of the print material (206). However, in some embodiments, a particular illustration need not be shown, and instead, only items for purchased or other rebates, coupons, etc., displayed.

A determination is then made by the e-reader as to whether additional user input has been received indicating the reader desires to virtually shop items displayed (block 208). When user input is not received indicating the reader desires to virtually shop, user input may be received causing the illustration to close enabling the reader to continue reading (block 210).

When user input is received indicating the reader desires to virtually shop, the e-reader receives user input indicating one or more items are to be added to a virtual shopping cart integrated directly within the e-reader software (block 212). Following receipt of the user input indicating one or more items are to be added to the virtual shopping cart, the e-reader causes the one or more items to be added to the virtual shopping cart (block 214). Additional user input is then received causing the illustration to close so that the reader may continue reading (block 216). Alternatively, the e-reader may automatically close the illustration after expiration of a predetermined time interval.

Further user input may be received indicating the user's desire to complete the virtual checkout, such a determination is made at block 218. When no user input has been received indicating a desire to complete the virtual check out, a determination is made as to whether user input is received indicating a user's desire to save the status of the virtual shopping cart (e.g., maintain the items in the virtual shopping cart) (block 220). When user input is not received that indicates the user desires to save the status of the virtual shopping cart, the e-reader deletes the one or more items from the virtual shopping cart (block 222). In contrast, when such user input is received, the e-reader saves the status of the virtual shopping cart for utilization, e.g., check out, at a later time (block 224).

When user input has been received indicating a desire to complete the virtual check out, the e-reader causes the display of a virtual shopping cart (block 226). Further, user input is received corresponding to requisite shipping and billing information in order to complete the virtual check out (block 228). Finally, the e-reader provides the reader with an order confirmation number (block 230).

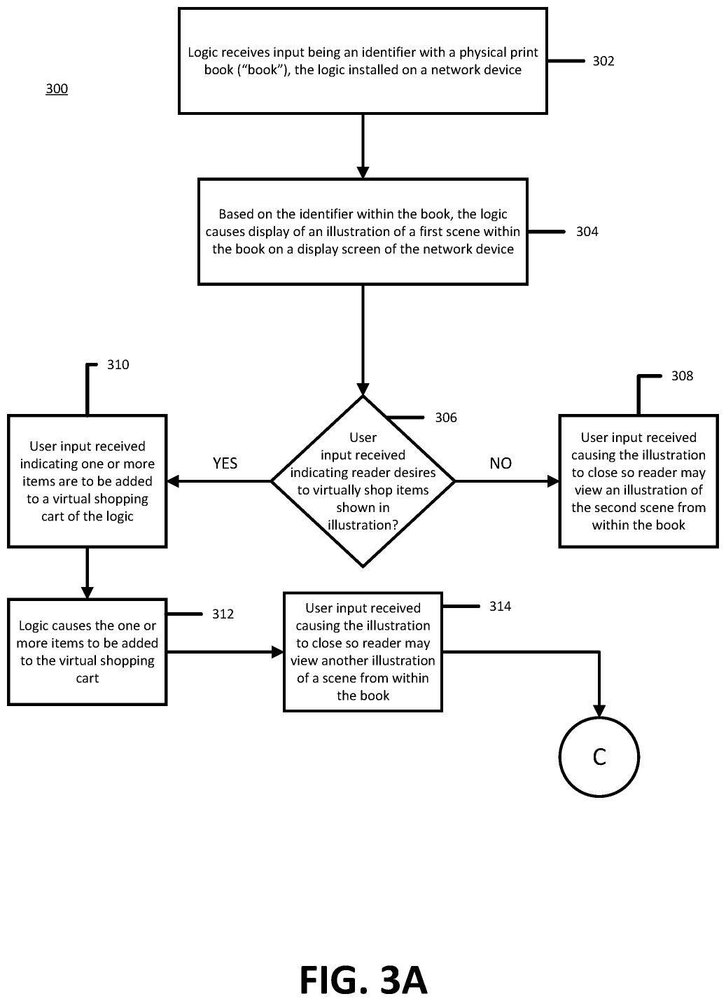

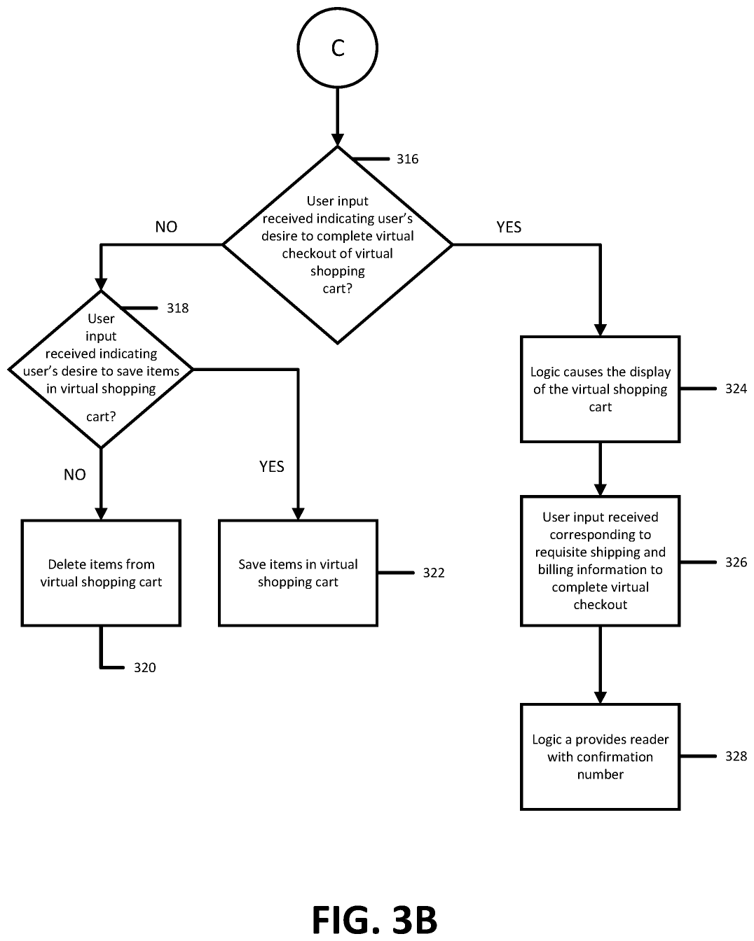

With reference to FIGS. 3A-3B, the term “identifier” may refer to any indicator than may be received by, scanned by or entered into an electronic device, wherein the identifier is unique to a specific book. Examples of an identifier may include, but are not limited or restricted to, a barcode, such as a quick response (QR) barcode, a Universal Unique Identifier (UUID). a radio-frequency identification (RFD) tag, a character string identifier (wherein each character string identifier corresponds to a specific book and is unique within a given database or databases), etc. One example of a character string identifier may be an alphanumeric identifier. Each block illustrated in FIGS. 3A-3B represents an operation performed in the method 300 of receiving user input via a software application corresponding to a selection of one or more items to place in a virtual shopping cart integrated directly within the software application, wherein the items correspond to an indicator located within a physical print book. The method 300 begins when logic, e.g., of a software application installed on a network device, receives input being an identifier within a physical print book (“book”) (block 302).

Based on the identifier within the book, the logic causes the display of an illustration of a first scene within the book on a display screen of the network device (block 304). A determination is then made by the logic as to whether additional user input has been received indicating the reader desires to virtually shop items displayed (block 306). When user input is not received indicating the reader desires to virtually shop, user input may be received causing the illustration to close enabling the reader to continue reading (block 308).

When user input is received indicating the reader desires to virtually shop, the logic receives user input indicating one or more items are to be added to a virtual shopping cart integrated directly within the software application (block 310). Following receipt of the user input indicating one or more items are to be added to the virtual shopping cart, the logic causes the one or more items to be added to the virtual shopping cart (block 312). Additional user input is then received causing the illustration to close so that the reader may continue reading (block 314). Alternatively, the logic may automatically close the illustration after expiration of a predetermined time interval.

Further user input may be received indicating the user's desire to complete the virtual checkout, such a determination is made at block 316. When no user input has been received indicating a desire to complete the virtual check out, a determination is made as to whether user input is received indicating a user's desire to save the status of the virtual shopping cart (e.g., maintain the items in the virtual shopping cart) (block 318). When user input is not received that indicates the user desires to save the status of the virtual shopping cart, the logic deletes the one or more items from the virtual shopping cart (block 320). In contrast, when such user input is received, the logic saves the status of the virtual shopping cart for utilization, e.g., check out, at a later time (block 322).

When user input has been received indicating a desire to complete the virtual check out, the logic causes the display of a virtual shopping cart (block 324). Further, user input is received corresponding to requisite shipping and billing information in order to complete the virtual check out (block 326). Finally, the logic provides the reader with an order confirmation number (block 328).

In some embodiments, the illustrations of each book are stored in one or more databases, e.g., stored locally or with cloud storage, wherein the logic utilizes the identifier to obtain one or more illustrations and subsequently display the illustrations on the display screen of the electronic device.

### III. Diagrammatic Representation

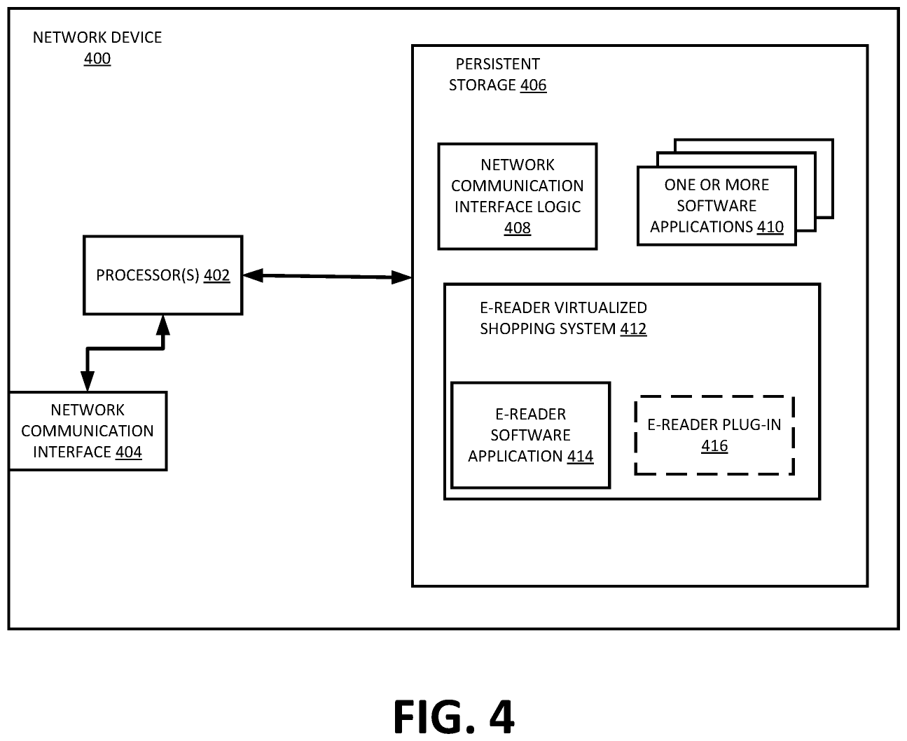

Referring now to FIG. 4, a block diagram of an exemplary embodiment of a network device including an e-reader software application and, optionally, an e-reader plug-in, installed thereon is shown in accordance with some embodiments. Herein, the network device 400 features a plurality of electronic components, including one or more hardware processors 402 (generally referred to as “processor”), a network communications interface 404 (that may also serve to illustrate an input/output device), and at least one non-transitory storage medium (“persistent storage”) 406. These components may be encased in a housing, which may be made entirely or partially of a rigid material (e.g., hard plastic, metal, glass, composites, or any combination thereof) that protects these components from certain environmental conditions.

The e-reader virtualized shopping system 412, in an embodiment may be stored on a non-transitory computer-readable storage medium (“persistent storage 406”) of a network device that includes a housing, which is made entirely or partially of a hardened material (e.g., hardened plastic, metal, glass, composite or any combination thereof) that protects the circuitry within the housing, namely one or more processors 402 that are coupled to a network communication interface 404. The communication interface 404, in combination with a network communication interface logic 412, enables communications with external network devices and/or other network appliances to transmit and receive data (e.g., digital files corresponding to print material, billing and shipping data, etc.). According to one embodiment of the disclosure, the network communication interface 404 may be implemented as a physical interface including one or more ports for wired connectors. Additionally, or in the alternative, the network communication interface 404 may be implemented with one or more radio units for supporting wireless communications with other electronic devices. The network communication interface logic 412 may include logic for performing operations of receiving and transmitting one or more objects via the network communication interface 404 to enable communication between the e-reader virtualized shopping system 412 and network devices via the a network (e.g., the internet) and/or cloud computing services.

According to one embodiment of the disclosure, the persistent storage 406 may include, (i) the network communication interface logic 408, (ii) one or more software applications 410, and (iii) the e-reader virtualized shopping system 412, which includes an e-reader software application 414 and, optionally, an e-reader plug-in 416. The e-reader software application 414 and the optional e-reader plug-in 416 each comprise logic that, when executed by the processor 402, cause performance of operations discussed herein. Of course, when implemented as hardware, one or more of these logic units could be implemented separately from each other.

### IV. General Methodology—Physical Print Book Embodiment

In yet another embodiment, the technological principles discussed above may be applied to print material set forth in a physical print book (“book”). In some embodiments, a book may include one or more indicators on a plurality of pages that can be “scanned” by a network device causing the network device to display items for purchase relevant to the context of the print material. As discussed above, the items need not be related to the context of the print material and need not be for purchase. Instead, the disclosure includes items that may be advertisements, rebates, coupons, exclusive content such as celebrity interviews or author insight, etc.

In such embodiments, a software application, such as an e-reader or plug-in discussed above, may include functionality for “scanning” the indicator, which may be a barcode in one embodiment. Upon scanning the indicator, the software application causes display of a pop-up, window, etc., illustrating one or more items. In the same manner as discussed above, the software application is configured to receive user input corresponding to a virtualized shopping experience (e.g., selection of one or more times, virtualized check out, etc.). In some embodiments, the indicator may appear at a corner of a page. In other embodiments, the indicator may appear at positions within the text such as in proximity to chapter headings, headings within the various chapters or even directly in the text. In some embodiments, the indicator may be imposed on the page behind the text.

In some embodiments, the e-reader software application and/or plug-in discussed above may include functionality for (2) displaying an e-book to a reader and receiving user input corresponding to activation of an electronic link within the e-book thereby initiating the virtualized shopping experience directly within the e-reader, and (2) scanning an indicator within a book and receiving user input corresponding a virtualized shopping experience directly within the e-reader. In such an embodiment, items selected via a virtualized shopping experience corresponding to an e-book and items selected via a virtualized shopping experience corresponding to a book may be added to a single virtualized shopping cart associated with the e-reader (i.e., integrated therein or provided via added functionality from the plug-in).

### V. General Methodology—Print Material Read Aloud

In yet other embodiments, the technological principles discussed above may be applied to print material that is “read aloud” by a network device, often referred to as an “audiobook.” However, the print material need not be limited to an audiobook and may include all digital media such as radio and audio corresponding to TV programs or movies. For purposes of clarity, embodiments will be discussed with respect to audiobooks; however, the same principles apply equally to digital media read aloud by a network device.

In some embodiments, an audiobook may be read aloud to a listener through operations performed by a software application referred to as a digital audio player. In a similar manner as discussed about with respect to the e-reader, the digital audio player may be specifically configured to include an integrated virtualized shopping cart, or a plug-in may be downloaded and installed on the network device to provide the additional functionality. In some embodiments, when the digital audio player is reading the audiobook aloud, the digital audio player may come across indicators embedded within the audiobook. Such indicators may be embedded prior to the time of downloading or streaming, or may be embedded automatically by the digital audio player (or plug-in). In the latter embodiment, the digital audio player or plug-in may embedded specific indicators at various locations within the audiobook, or at locations specified by the author, publicist, etc. Responsive to encountering an indicator during reading of the audiobook, the digital audio player (or plug-in) performs operations resulting in the display of a pop-up or window illustrating one or more items as discussed above. The same operations discussed above may be performed with respect to receiving user input in order to enable a virtualized shopping experience.

In some embodiments, a single software application may include functionality pertaining to both an e-reader and a digital audio player (including one or more plug-ins, if needed) such that items selected during any of reading an e-book, reading a physical print book and/or listening to an audiobook are added to a single virtualized shopping cart enabling an easy and seamless checkout experience for the user of the network device.

While particular embodiments of the present invention have been described, it is understood that various different modifications within the scope and spirit of the invention are possible.

What is claimed is:

1. A computerized method of a virtualized shopping experience on a network device, the method comprising:
detecting, by an e-reader software application processing on the network device, first user input corresponding to selection of an indicator within an e-book;
displaying, by the e-reader software application, an image depicting a first item;
responsive to receiving second user input indicating selection of the first item, adding, by the e-reader software application, the first item to a virtual shopping cart; and
responsive to receiving third user input, completing, by the e-reader software application, a virtualized check out process.

2. The computerized method of claim 1, wherein a plug-in software application is processing on the network device and providing additional functionality to the e-reader software application, wherein the additional functionality includes performance of operations causing (i) detection of the selection of the indicator, (ii) display of the image depicting the first item, (iii) addition of the first item to the virtual shopping cart, and (iv) completion of the virtualized check out process.

3. The computerized method of claim 1, wherein the indicator is an electronic link within the e-book that appears as a word within the text.

4. The computerized method of claim 1, wherein the first item is an item that corresponds to a portion of the e-book.

5. The computerized method of claim 1, wherein the first item is available for purchase.

6. The computerized method of claim 1, wherein the first item is a rebate, a coupon, a video pertaining to author insight, or a video pertaining to a celebrity interview.

7. The computerized method of claim 1, wherein the e-reader software application includes logic directly integrating the virtual shopping cart therein.

8. The computerized method of claim 1, wherein operations of (1) detecting the first user input corresponding to the selection of the indicator, (2) displaying the image depicting the first item, (3) adding the first item to the virtual shopping cart, and (4) completing the virtualized check out process are performed without causing a user to enter user input into an application other than the e-reader software application.
